(19) United States
(12) Patent Application Publication
(10) Pub. No.: US 2003/0218087 A1
(43) Pub. Date: Nov. 27, 2003

(54) Cutting tool of a paper shredding machine

(76) Inventor: Ming-Hui Ho, Hsin Chuang City (TW)

Correspondence Address: Keith Kline, PRO-TECHTOR INTERNATIONAL SERVICES, 20775 Norada Court, Saratoga, CA, 95070-3018, US

(21) Appl. No.: 10/152,962

(22) Filed: May 21, 2002

(51) Int. Cl. B02C 18/16

(52) U.S. Cl. 241/236

(57) ABSTRACT

A cutting tool of a paper shredding machine includes a pair of cylindrical roller cutters; each roller cutter has a hexagonal shaft rod and a plurality of differential breaking blades inserted on the shaft rod; a gasket spaces between two adjacent differential breaking blades; therefore, two differential breaking blades of two cylindrical roller cutters are assembled in a staggering method, wherein each differential breaking blade has a first set of blades and a second set of blades. The features of the innovative present invention are that no gap exists between the first and the second blades which are either tightly sealed or of a single-blade structure with more thickness thereby preventing the cut paper shreds from falling between the first set of blades and the second set of blades to cause a breakdown of the paper shredding machine.

### BACKGROUND OF THE INVENTION

1) Field of the Invention

The present invention relates to a cutting tool of a paper shredding machine, more especially to a first set of blades and a second set of blades of a differential breaking blade on a cylindrical roller cutter; the first and second sets of blades are connected tightly without any gap existing inbetween; therefore, during the procedure of cutting and shredding paper, paper shred will not be stuck at the first and second sets of blades thereby preventing the breakdown of the paper shredding machine.

2) Description of the Prior Art

The traditional cutting tool of a paper shredding machine, as shown in FIG. 1, comprises a pair of cylindrical roller cutters (1, 1′) which are driven by a driving device including a motor and a gear. Each cylindrical roller cutter (1, 1′) has a polygonal shaft rod (2), as the one shown in FIG. 1, and a plurality of cutting blades (4) inserted on the shaft rod (2). A spacer (6) is disposed between two adjacent cutting blades (4) such that the cutting blades (4) of the two cylindrical roller cutter (1, 1′) are assembled in a staggering method. The traditional cutting blades (4) has a shaft hole in a shape fitting with the shape of the shaft rod (2); furthermore, the peripheral rim of the shaft hole is formed with a plurality of cutting edges (8) (four shown in FIG. 1) spaced with an equal azimuth.

Although the abovementioned traditional paper shredding machine is capable of achieving an effect at a certain degree, it still has a serious shortcoming.

Referring to FIGS. 2 and 3, the first and second sets of cutting blades (4a, 4b) of the traditional cutting blade (4) are not completely sealed and a gap (A) exists inbetween. When the cutting tool of the paper shredding machine continuously shreds paper for a long term, the gap (A) cumulates the cut shreds, especially those of damp paper; after a long while, the gap (A) between the first and second sets of blades expands wider to cause the separation of affixed cutting edges (8a, 8b) thereby causing a breakdown of the paper machine.

### SUMMARY OF THE INVENTION

Therefore, the primary objective of the present invention is to provide a cutting tool of a paper shredding machine by designing a first set of blades and a second set of blades of a differential breaking blade of a cylindrical roller cutter into a tightly sealed structure without any gap; therefore, during the procedure of using the cutting tool of the paper shredding machine to shred paper, definitely no shred will be stuck such that the quality of the cutting tool of the paper shredding machine is assured to have less breakdown situations.

Another objective of the present invention is to provide a cutting tool of a paper shredding machine, wherein the differential breaking blades of the cylindrical roller cutter is designed with more thickness such that no any paper shred will be stuck therein.

To enable a further understanding of the structural features and the technical contents of the present invention, the brief description of the drawings below is followed by the detailed description of the preferred embodiment.

### BRIEF DESCRIPTION OF THE DRAWINGS

FIG. 1 is a pictorial and schematic drawing of a traditional cutting tool for shredding paper.

FIG. 2 is a plane drawing of the assembly of a first set of blades and a second set of blades of a cutting blade of the traditional paper shredding machine.

FIG. 3 is a lateral plane drawing of the assembly of a first set of blades and a second set of blades of a cutting blade of the traditional paper shredding machine.

FIG. 4 is a pictorial and schematic drawing of the present invention.

FIG. 5 is a bird's-eye view drawing of a cutting tool of a paper shredding machine of the present invention.

FIG. 6 is a plane drawing of the assembly of a first set of blades and a second set of blades of a differential breaking blade of the cutting tool of the paper shredding machine of the present invention.

FIG. 7 is a lateral plane drawing of the assembly of a first set of blades and a second set of blades of a differential breaking blade of the cutting tool of the paper shredding machine of the present invention.

FIG. 8 is a drawing of an exemplary embodiment of the differential breaking blade of the cutting tool of the paper shredding machine of the present invention.

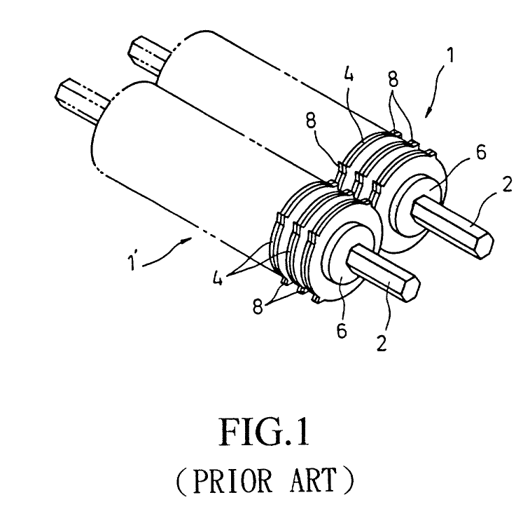

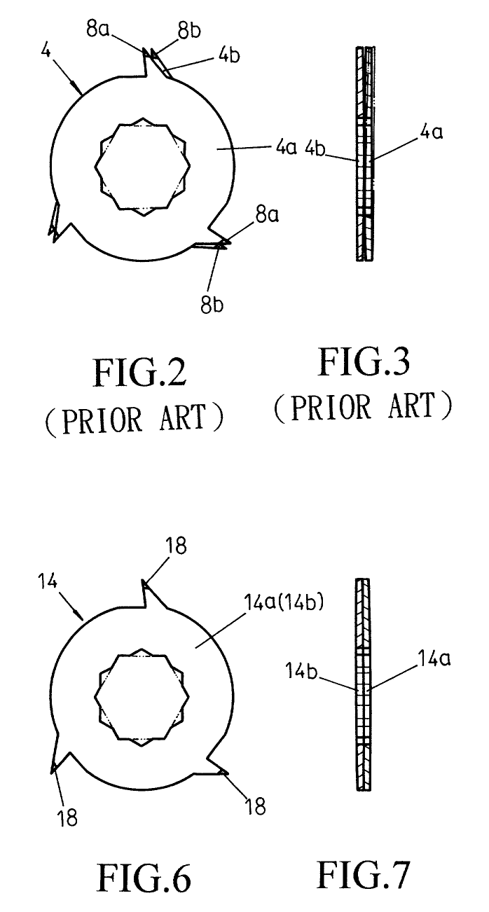

### DETAILED DESCRIPTION OF THE PREFERRED EMBODIMENTS

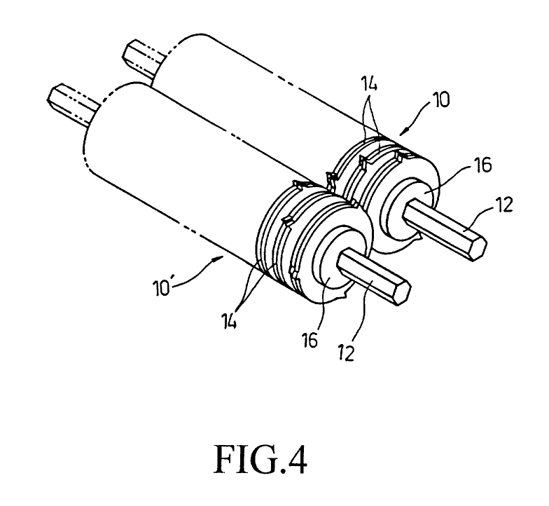

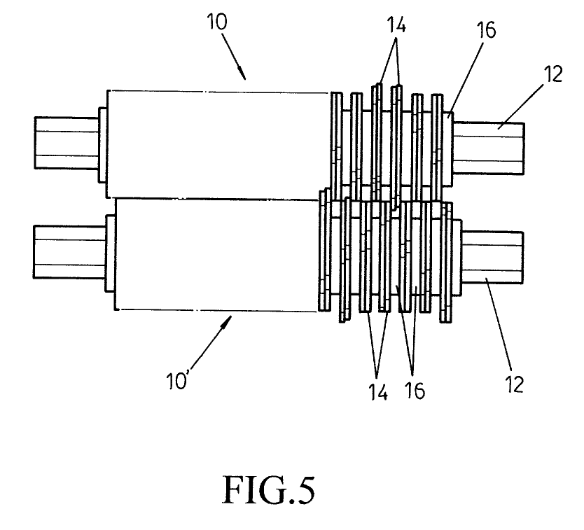

Referring to FIGS. 4 and 5, the present invention comprises two cylindrical roller cutters (10, 10′); each roller cutter (10, 10′) has a hexagonal shaft rod (12) and a plurality of differential breaking blades (14) inserted on the shaft rod (12); a gasket (16) spaces between two adjacent differential breaking blades (14) of two cylindrical roller cutters (10, 10′) in a staggering method; each differential breaking blade (14) comprises a first set of blades (14a) and a second set of blades (14b).

Referring to FIGS. 6 and 7, the first and second sets of blades (14a, 14b) of the differential breaking blades (14) are tightly sealed without any gap existed inbetween. When the cutting tool of the paper shredding machine shreds paper, no paper shreds fall between the first and second sets of blades (14a, 14b). Therefore, the cutting edges (18) of the first and second sets of blades (14a, 14b) connect to form one unit. For a long term application, not only the cutting function of two differential breaking blades (14) staggered in disposition cuts paper into long strips, the cutting edges (18) of the differential breaking blades (14) also shred the paper strips into segments thereby definitely causing no breakdown of the cutting tool of the paper shredding machine.

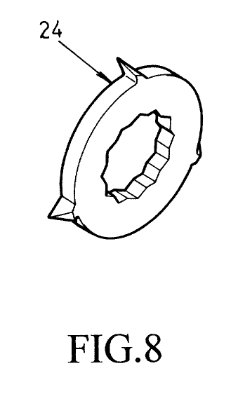

FIG. 8 shows another exemplary embodiment of a differential breaking blade (24) of the present invention; wherein, the differential breaking blade (24) with more thickness is only a single piece; the thickness thereof equals to the total thickness of the first and second sets of blades (14a, 14b) of the regular differential breaking blade (14). This differential breaking blade (24) is not formed by connecting two pieces, therefore, definitely no shred will stuck inbetween.

In summation of the abovementioned, the practical and innovative cutting tool of the paper shredding machine of the present invention is capable of efficiently and specifically eliminating the shortcomings of the currently available paper shredding machine.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A cutting tool of a paper shredding machine comprises two cylindrical roller cutter rotating in opposite directions; each roller cutter has a polygonal shaft rod and a plurality of differential breaking blades inserted on the shaft rod; a gasket is disposed to space between two adjacent differential breaking blades allowing the differential breaking blades on two cylindrical roller cutters to be assembled in staggering method, wherein each differential breaking blade comprises a first set of blades and a second set of blades; the cutting tool of the paper shredding machine is characterized that:
the first and second sets of blades are tightly connected without any gap existed inbetween so as to prevent the paper shreds cut by the cutting tool of the paper shredding machine from falling between the first and second sets of blades to cause a breakdown of the paper shredding machine.

2. A cutting tool of a paper shredding machine according to claim 1, wherein the differential breaking blades of the first and second sets of blades are sealed tightly into one unit.

3. A cutting tool of a paper shredding machine according to claim 1, wherein the differential breaking blade is a single piece structure with more thickness.
